(19) United States
(12) Patent Application Publication
(10) Pub. No.: US 2012/0075750 A1
(43) Pub. Date: Mar. 29, 2012

(54) INTEGRATED LOAD-UNLOAD RAMP STRUCTURE WITH DOWNSTREAM SPOILER AND SLIT-SHROUD FOR A HARD-DISK DRIVE

(76) Inventors: Andre Chan, Palo Alto, CA (US); Ferdinand Hendriks, Mogan Hill, CA (US)

(21) Appl. No.: 12/891,695

(22) Filed: Sep. 27, 2010

(51) Int. Cl. G11B 21/24

(52) U.S. Cl. 360/294; G9B/21.028

(57) ABSTRACT

An integrated load-unload ramp structure with a downstream spoiler and a slit-shroud for a hard-disk drive (HDD). The integrated load-unload (L/UL) ramp structure includes a L/UL ramp-structure portion, at least one downstream spoiler integrally attached to the L/UL ramp-structure portion, and a slit-shroud including at least one wing, the slit-shroud integrally attached to the L/UL ramp-structure portion. The L/UL ramp-structure portion is configured both for loading, and for unloading, at least one head-slider from at least one magnetic-recording disk. The downstream spoiler is configured for operation in an airflow downstream from the head-slider. In addition, the slit-shroud is configured to suppress axial airflow components in close proximity to an outside-diameter (OD) edge of the magnetic-recording disk. A HDD including the integrated L/UL ramp structure and a method for assembling a HDD with an integrated L/UL ramp structure are also provided.

### TECHNICAL FIELD

Embodiments of the present invention relate generally to the field of hard-disk drives (HDDs).

### BACKGROUND

With the advance of HDD technology, the spacing between a magnetic-recording head and a magnetic-recording disk has become progressively smaller, on the order of a few nanometers (nm). Consequently, small disturbances in airflow that can give rise to airflow turbulence that can affect the head-to-disk spacing, or fly-height, have become of greater concern. For example, turbulence in the air-stream can give rise to head-positioning errors, thus giving rise to errors in the recording, or retrieval, of information stored on the magnetic-recording disk. Thus, engineers and scientists engaged in the development of HDDs are becoming increasingly more interested in providing an HDD environment of low vibration for the storage of information, and HDD designs at reduced cost.

### SUMMARY

Embodiments of the present invention include an integrated load-unload (L/UL) ramp structure with a downstream spoiler and a slit-shroud for a hard-disk drive (HDD). The integrated L/UL ramp structure includes a L/UL ramp-structure portion, at least one downstream spoiler integrally attached to the L/UL ramp-structure portion, and a slit-shroud including at least one wing, the slit-shroud integrally attached to the L/UL ramp-structure portion. The L/UL ramp-structure portion is configured both for loading, and for unloading, at least one head-slider from at least one magnetic-recording disk. The downstream spoiler is configured for operation in an airflow downstream from the head-slider. In addition, the slit-shroud is configured to suppress axial airflow components in close proximity to an outside-diameter (OD) edge of the magnetic-recording disk. Embodiments of the present invention also include a HDD including the integrated L/UL ramp structure and a method for assembling a HDD with an integrated L/UL ramp structure.

### DESCRIPTION OF THE DRAWINGS

The accompanying drawings, which are incorporated in and form a part of this specification, illustrate embodiments of the invention and, together with the description, serve to explain the embodiments of the invention:

FIG. 1 is a plan view illustrating the arrangement of components within the example environment of a hard-disk drive (HDD) that includes an integrated load-unload (L/UL) ramp structure with a downstream spoiler and a slit-shroud, in accordance with one or more embodiments of the present invention.

FIG. 2 is a perspective view illustrating an integrated L/UL ramp structure with a downstream spoiler and a slit-shroud of FIG. 1, in accordance with one or more embodiments of the present invention.

FIG. 3 is another perspective view from another viewpoint illustrating the integrated L/UL ramp structure with the downstream spoiler and the slit-shroud of FIG. 2, in accordance with one or more embodiments of the present invention.

FIG. 4 is a plan view illustrating the integrated L/UL ramp structure with the downstream spoiler and the slit-shroud of FIG. 2, in accordance with one or more embodiments of the present invention.

FIG. 5 is a side view looking in a downstream direction at an upstream-facing side of a bracket portion of the integrated L/UL ramp structure illustrating the integrated L/UL ramp structure with the downstream spoiler and the slit-shroud of FIG. 2, in accordance with one or more embodiments of the present invention.

FIG. 6 is a side view looking in an upstream direction at a downstream-facing side of the bracket portion of the integrated L/UL ramp structure illustrating the integrated L/UL ramp structure with the downstream spoiler and the slit-shroud of FIG. 2, in accordance with one or more embodiments of the present invention.

FIG. 7 is a plot of pressure versus time, in accordance with one or more embodiments of the present invention shown on the right half of the figure, at a location where a wing of the slit-shroud is located; and, a plot of pressure versus time, of the prior art shown on the left half of the figure, at the same location but without the wing of the slit-shroud being present.

FIG. 8 is a perspective view illustrating an integrated L/UL ramp structure with a downstream spoiler and a slit-shroud including at least one head-slider channel for accommodating an unloading operation of a head-slider without interference of the head-slider with the slit-shroud, shown from a viewpoint similar to that of FIG. 2, in accordance with one or more embodiments of the present invention.

FIG. 9 is flow chart illustrating a method for assembling the hard-disk drive including the integrated L/UL ramp structure with the downstream spoiler and the slit-shroud, in accordance with one or more embodiments of the present invention.

The drawings referred to in this description should not be understood as being drawn to scale except if specifically noted.

### DESCRIPTION OF EMBODIMENTS

Reference will now be made in detail to the alternative embodiments of the present invention. While the invention will be described in conjunction with the alternative embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following description of embodiments of the present invention, numerous specific details are set forth in order to provide a thorough understanding of the present invention. However, it should be appreciated that embodiments of the present invention may be practiced without these specific details. In other instances, well known methods, procedures, and components have not been described in detail as not to unnecessarily obscure embodiments of the present invention. Throughout the drawings, like components are denoted by like reference numerals, and repetitive descriptions are omitted for clarity of explanation if not necessary.

### Physical Description of Embodiments of an Integrated Load-Unload Ramp Structure with Downstream Spoiler and Slit-Shroud for a Hard-Disk Drive, and a Hard-Dish Drive Included the Same

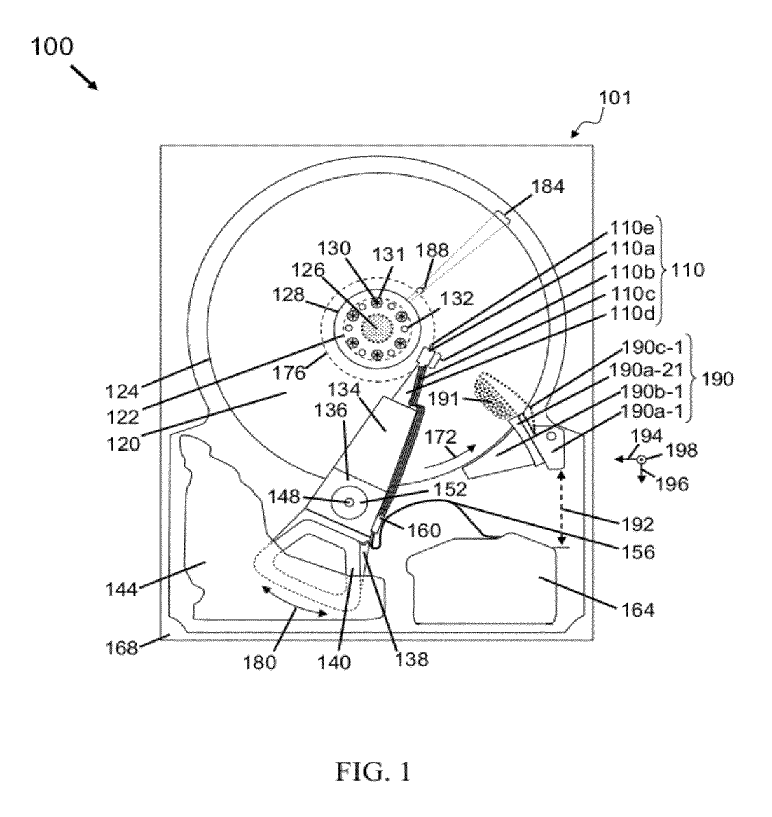

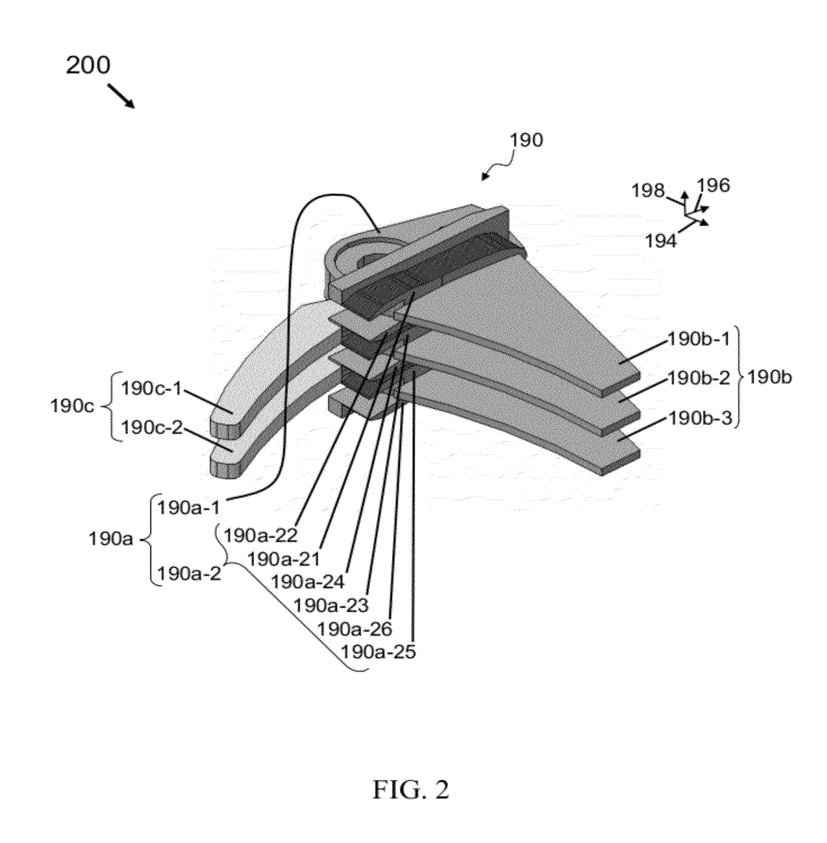

With reference now to FIG. 1, in accordance with one or more embodiments of the present invention, a plan view 100 of a hard-disk drive (HDD) 101 is shown. FIG. 1 illustrates the arrangement of components within HDD 101 including an integrated load-unload (L/UL) ramp structure 190 with a downstream spoiler, for example, downstream spoiler 190c-1, and a slit-shroud 190b (see at least FIG. 2) including at least one wing, for example, wing 190b-1. HDD 101 includes at least one head-gimbal assembly (HGA) 110 including a magnetic-recording head 110a, a lead-suspension 110c attached to the magnetic-recording head 110a, and a load beam 110d attached to a head-slider 110b, which includes the magnetic-recording head 110a at a distal end of the head-slider 110b; the head-slider 110b is attached at the distal end of the load beam 110d to a gimbal portion of the load beam 110d. HDD 101 also includes at least one magnetic-recording disk 120 rotatably mounted on a spindle 126 and a drive motor (not shown) mounted in a disk-enclosure base 168 and attached to the spindle 126 for rotating the magnetic-recording disk 120. The magnetic-recording head 110a that includes a write element, a so-called writer, and a read element, a so-called reader, is disposed for respectively writing and reading information, referred to by the term of art, “data,” stored on the magnetic-recording disk 120 of HDD 101. The magnetic-recording disk 120, or a plurality (not shown) of magnetic-recording disks, may be affixed to the spindle 126 with a disk clamp 128. The disk clamp 128 is provided with fastener holes, for example, fastener hole 130, and clamps the magnetic-recording disk 120, or magnetic recording disks (not shown), to a hub (not shown) with fasteners, of which fastener 131 is an example. The disk clamp 128 is also provided with balance holes, of which balance hole 132 is an example, in which counterweights may be inserted to reduce vibrations of the magnetic-recording disk 120. HDD 101 further includes an arm 134 attached to HGA 110, a carriage 136, a voice-coil motor (VCM) that includes an armature 138 including a voice coil 140 attached to the carriage 136; and a stator 144 including a voice-coil magnet (not shown); the armature 138 of the VCM is attached to the carriage 136 and is configured to move the arm 134 and HGA 110 to access portions of the magnetic-recording disk 120, as the carriage 136 is mounted on a pivot-shaft 148 with an interposed pivot-bearing assembly 152.

With further reference to FIG. 1, in accordance with one or more embodiments of the present invention, electrical signals, for example, current to the voice coil 140 of the VCM, write signals to and read signals from the magnetic-recording head 110a, are provided by a flexible cable 156. Interconnection between the flexible cable 156 and the magnetic-recording head 110a may be provided by an arm-electronics (AE) module 160, which may have an on-board pre-amplifier for the read signal, as well as other read-channel and write-channel electronic components. The flexible cable 156 is coupled to an electrical-connector block 164, which provides electrical communication through electrical feedthroughs (not shown) provided by the disk-enclosure base 168. The disk-enclosure base 168, also referred to as a base casting, depending upon whether the disk-enclosure base 168 is cast, in conjunction with an HDD cover (not shown) provides a sealed, except for a breather filter (not shown), protective disk enclosure for the information storage components of HDD 101.

With further reference to FIG. 1, in accordance with one or more embodiments of the present invention, other electronic components (not shown), including a disk controller and servo electronics including a digital-signal processor (DSP), provide electrical signals to the drive motor, the voice coil 140 of the VCM and the magnetic-recording head 110a of HGA 110. The electrical signal provided to the drive motor enables the drive motor to spin providing a torque to the spindle 126 which is in turn transmitted to the magnetic-recording disk 120 that is affixed to the spindle 126 by the disk clamp 128; as a result, the magnetic-recording disk 120 spins in a direction 172. The spinning magnetic-recording disk 120 creates an airflow including an air-stream, and a self-acting air bearing on which the air-bearing surface (ABS) of the head-slider 110b rides so that the head-slider 110b flies in proximity with the recording surface of the magnetic-recording disk 120 to avoid contact with a thin magnetic-recording medium of the magnetic-recording disk 120 in which information is recorded. The electrical signal provided to the voice coil 140 of the VCM enables the magnetic-recording head 110a of HGA 110 to access a track 176 on which information is recorded. As used herein, “access” is a term of art that refers to operations in seeking the track 176 of the magnetic-recording disk 120 and positioning the magnetic-recording head 110a on the track 176 for both reading data from, and writing data to, the magnetic-recording disk 120. The armature 138 of the VCM swings through an arc 180 which enables HGA 110 attached to the armature 138 by the arm 134 to access various tracks on the magnetic-recording disk 120. Information is stored on the magnetic-recording disk 120 in a plurality of concentric tracks (not shown) arranged in sectors on the magnetic-recording disk 120, for example, sector 184. Correspondingly, each track is composed of a plurality of sectored track portions, for example, sectored track portion 188. Each sectored track portion 188 is composed of recorded data and a header containing a servo-burst-signal pattern, for example, an ABCD-servo-burst-signal pattern, information that identifies the track 176, and error correction code information. In accessing the track 176, the read element of the magnetic-recording head 110a of HGA 110 reads the servo-burst-signal pattern which provides a position-error-signal (PES) to the servo electronics, which controls the electrical signal provided to the voice coil 140 of the VCM, enabling the magnetic-recording head 110a to follow the track 176. Upon finding the track 176 and identifying a particular sectored track portion 188, the magnetic-recording head 110a either reads data from the track 176, or writes data to, the track 176 depending on instructions received by the disk controller from an external agent, for example, a microprocessor of a computer system.

Embodiments of the present invention encompass within their scope a HDD 101 that includes at least one magnetic-recording disk 120, at least one head-slider 110b, at least one magnetic-recording head 110a disposed at a distal end of the head-slider 110b and an integrated L/UL ramp structure 190 with a downstream spoiler, for example, downstream spoiler 190c-1, and a slit-shroud 190b including at least one wing, for example, wing 190b-1. In accordance with one or more embodiments of the present invention, the head-slider 110b is configured to access data on the magnetic recording disk 120; and, the magnetic-recording head 110a is configured to read data from, and to write data to, the magnetic-recording disk 120. In accordance with one or more embodiments of the present invention, the integrated L/UL ramp structure 190 includes a L/UL ramp-structure portion 190a (see at least FIG. 2), at least one downstream spoiler, for example, downstream spoiler 190c-1, integrally attached to the L/UL ramp-structure portion 190a, and the slit-shroud 190b (see at least FIG. 2) including at least one wing, for example, wing 190b-1, integrally attached to the L/UL ramp-structure portion 190a. In accordance with one or more embodiments of the present invention, the L/UL ramp-structure portion 190a is configured both for loading, and for unloading, the head-slider 110b from the magnetic-recording disk 120. In accordance with one or more embodiments of the present invention, the downstream spoiler, for example, downstream spoiler 190c-1, is configured for operation in an airflow downstream from a head-slider, similar to head-slider 110b but disposed under the magnetic-recording disk 120, as well as downstream from the arm 134.

As used herein, component parts of HDD 101 have different sides referred to by at least the following terms of art: a side facing an inside diameter (ID) of a magnetic-recording disk, for example, similar to the magnetic-recording disk 120, referred to herein as an ID side, which is applicable to component parts situated between the ID and outside diameter of the magnetic-recording disk; a side facing an outside diameter (OD) of the magnetic-recording disk, an OD side, which likewise is applicable to component parts situated between the ID and OD of the magnetic-recording disk; a side facing into the direction 172 of motion of the magnetic-recording disk and, thus, into the direction of airflow, a leading-edge (LE) side; a side facing away from the direction 172 of motion of the magnetic-recording disk and, thus, away from the direction of airflow, a trailing-edge (TE) side; a side facing towards the bottom of the disk-enclosure base 168, a bottom side; a side facing away from the bottom of the disk-enclosure base 168 and, thus, towards the disk-enclosure cover (not shown), a top side; a side facing the recording surface of the magnetic-recording disk, a disk-facing side; and, a side facing away from and opposite to a side facing the recording surface of the magnetic-recording disk, an opposite-to-disk-facing side.

In accordance with one or more embodiments of the present invention, the slit-shroud 190b including at least one wing, for example, wing 190b-1, is configured to suppress axial airflow components in close proximity to an OD edge 124 of the magnetic-recording disk 120. In the description of HDD 101, embodiments of the present invention incorporate within the environment of HDD 101 subsequently described embodiments of the present invention for the integrated L/UL ramp structure 190 and the method for assembling an HDD with an integrated L/UL ramp structure 190.

With further reference to FIG. 1, in accordance with one or more embodiments of the present invention, HDD 101 may include a downstream spoiler, for example, downstream spoiler 190c-1, such that longitudinal axis of the downstream spoiler, for example, downstream spoiler 190c-1, is disposed in a substantially radial orientation with respect to the magnetic-recording disk 120, and such that a length of the longitudinal axis of the downstream spoiler, for example, downstream spoiler 190c-1, is about one half a distance from the OD edge 124 to an ID edge 122 of the magnetic-recording disk 120. The inventors have found through extensive and detailed experiments that the region in the vicinity of, and on the downstream side of, a L/UL ramp structure without a slit-shroud is a region of intense turbulent pressure fluctuations in a HDD. Therefore, in accordance with one or more embodiments of the present invention, the downstream spoiler, for example, downstream spoiler 190c-1, is configured to produce a quiet zone 191, also referred to by the term of art, “stagnation zone,” in airflow above the magnetic-recording disk 120; the quiet zone 191 is located ahead of a leading edge of the downstream spoiler, for example, downstream spoiler 190c-1, as shown in FIG. 1. Since such turbulent pressure fluctuation may cause buffeting of the head-slider 110b that results in increased levels of track misregistration (TMR), the integrated L/UL ramp structure 190 is configured to reduce TMR of the head-slider 110b when the head-slider 110b accesses data on the magnetic-recording disk 120, in accordance with one or more embodiments of the present invention.

With further reference to FIG. 1, in accordance with one or more embodiments of the present invention, a disk-edge-facing side of a wing, for example, wing 190b-1, of the slit-shroud 190b is disposed in proximity to a magnetic-recording disk, for example, the magnetic-recording disk 120, and conforms to a curved contour of an OD edge of the magnetic-recording disk, for example, the OD edge 124 of the magnetic-recording disk 120. The inventors have found in their investigations that the region in the vicinity of the OD edge of a magnetic-recording disk, for example, the OD edge 124 of magnetic-recording disk 120, is a region in which unstable shear layers of airflow are shed from the magnetic-recording disk. These shear layers result from air moving in the Ekman layers on the recording surface of the magnetic-recording disk. Without shrouding these shear layers cause axial flows, typically on the order of several meters/second (m/sec), just outside the OD edge of a magnetic-recording disk, for example, the OD edge 124 of magnetic-recording disk 120, which adds to flow-induced vibration (FIV) of the magnetic-recording disk, or disks. The wings of the slit-shroud, of which wing 190b-1 of slit-shroud 190b is an example, suppress axial flow components near the OD edge of a magnetic-recording disk, for example, the OD edge 124 of magnetic-recording disk 120. Thus, in accordance with one or more embodiments of the present invention, turbulent kinetic energy in the vicinity of the HGA, or HGAs, and the L/UL ramp may be reduced. Moreover, the unshrouded OD edge of the magnetic-recording disk entrains air along the entire arc length of the unshrouded perimeter of the magnetic-recording disk. The amount of entrained air and turbulence level increase in the downstream, typically counter-clockwise, direction, until the entrained air reaches the L/UL ramp. Both turbulent mixing of the air and the aerodynamic drag of the L/UL ramp contribute to spindle power aerodynamic loss. Thus, to reduce spindle power aerodynamic loss, in accordance with one or more embodiments of the present invention, a thickness of a wing of the slit-shroud, for example, wing 190b-1 of slit-shroud 190b, is on an order of a thickness of the magnetic-recording disk 120. In accordance with one or more embodiments of the present invention, the thickness of the wing of the slit-shroud, for example, wing 190b-1 of slit-shroud 190b, is less than, or alternatively, equal to, from about 0.5 millimeter (mm) to 1.0 mm. In accordance with one or more embodiments of the present invention, the clearance between the wing of the slit-shroud, for example, wing 190b-1 of slit-shroud 190b, and the OD edge 124 of the magnetic-recording disk 120 is equal to about 0.5 mm.

With further reference to FIG. 1, in accordance with one or more embodiments of the present invention, HDD 101 may further include an insertion space 192 for the integrated L/UL ramp structure 190; the insertion space 192 is configured to receive the integrated L/UL ramp structure 190 in an assembly operation, and is configured to allow a sliding-insertion operation of at least one downstream spoiler, for example, downstream spoiler 190c-1, of the integrated L/UL ramp structure 190 into proximity with a recording surface of the magnetic recording disk 120. Alternatively, in accordance with one or more embodiments of the present invention, the downstream spoiler, for example, downstream spoiler 190c-1, may be configured to pivot and be locked into position adjacent to the location where the quiet zone 191 is to be created in the airflow above the magnetic-recording disk, for example, magnetic-recording disk 120. As shown in FIG. 1, in accordance with one or more embodiments of the present invention, the sliding-insertion operation of the integrated L/UL ramp structure 190 may include merging the integrated L/UL ramp structure 190 with the magnetic-recording disk 120; merging may further include sliding the integrated L/UL ramp structure 190 in a linear translation across the insertion space 192, for example, in the direction of the dashed arrow labeling the insertion space 192 in FIG. 1.

As shown in FIG. 1, the direction of the arrow labeling the insertion space 192 is about parallel to the arrow 196 of a triad used to indicate the relative orientation of components in HDD 101; the direction of arrow 196 is about parallel to the long side of the disk-enclosure base 168 of HDD 101; the direction of arrow 194 is perpendicular to arrow 196 and is about parallel to the short side of the disk-enclosure base 168 of HDD 101; and, arrow 198, which is indicated by the arrow head of arrow 198, is about perpendicular to the plane of the disk-enclosure base 168, as well as the plane of the recording surface of the magnetic recording disk 120, and therefore is perpendicular to arrows 194 and 196. Thus, the triad of arrows 194, 196 and 198 are related to one another by the right-hand rule for vectors in the direction of the arrows 194, 196 and 198 such that the cross product of the vector corresponding to arrow 194 and the vector corresponding to arrow 196 produces a vector parallel and oriented in the direction of the arrow 198. The triad of arrows 194, 196 and 198 is subsequently used to indicate the orientation of views for subsequently described drawings of the integrated L/UL ramp structure 190, of which FIG. 2 is an example next described.

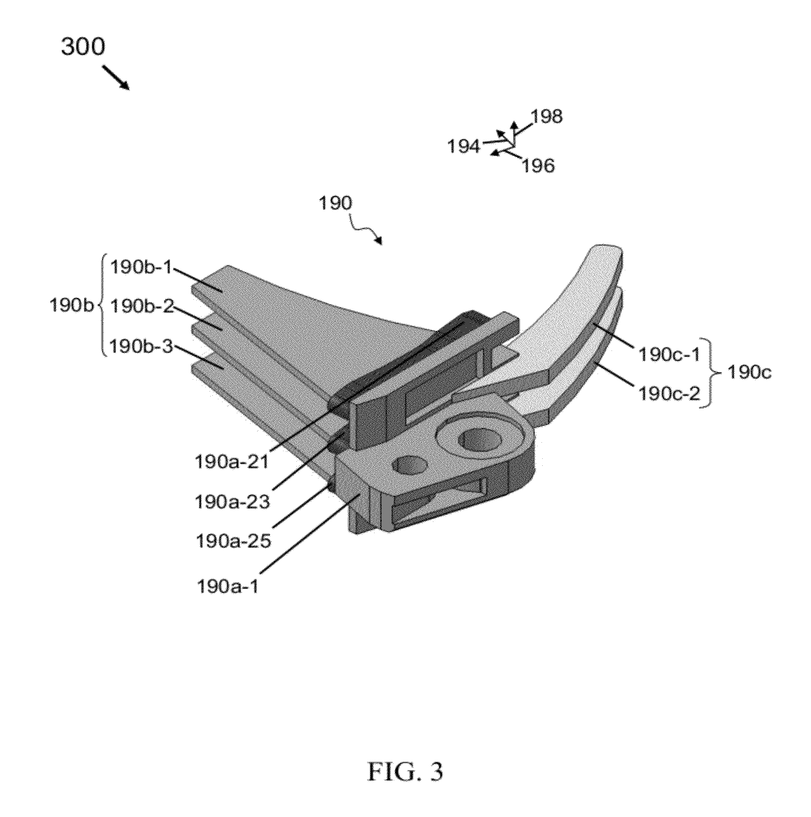

With reference now to FIGS. 2 and 3 and further reference to FIG. 1, in accordance with one or more embodiments of the present invention, perspective views 200 and 300 are shown of the integrated L/UL ramp structure 190 including a L/UL ramp-structure portion 190a, at least one downstream spoiler 190c-1, and a slit-shroud 190b including at least one wing 190b-1. As shown in FIGS. 2 and 3, the triad of arrows 194, 196 and 198 indicates the orientation in which the integrated L/UL ramp structure 190 is viewed in the respective perspective views 200 and 300. In accordance with one or more embodiments of the present invention, the downstream spoiler 190c-1 and the slit-shroud 190b are integrally attached to the L/UL ramp-structure portion 190a. In accordance with one or more embodiments of the present invention, the L/UL ramp-structure portion 190a is configured both for loading, and for unloading, at least one head-slider 110b from at least one magnetic-recording disk 120. In accordance with one or more embodiments of the present invention, the downstream spoiler 190c-1 is configured for operation in an airflow downstream from a head-slider, similar to the head-slider 110b but disposed under the magnetic-recording disk 120, without limitation thereto, as embodiments of the present invention may also include a downstream spoiler disposed above the recording surface of the magnetic-recording disk 120 in proximity to which head-slider 110b flies; and, the slit-shroud 190b is configured to suppress axial airflow components in close proximity to the OD edge 124 of the magnetic-recording disk 120. Although only a single magnetic recording disk 120 is shown in FIG.1, embodiments of the present invention also include within their spirit and scope an HDD including a plurality of magnetic-recording disks and magnetic-recording heads. Thus, in accordance with one or more embodiments of the present invention, the perspective view 200 of the integrated L/UL ramp structure 190 illustrates a complex structure consistent with an HDD 101 including a plurality of magnetic-recording disks and magnetic-recording heads, as is next described.

With further reference to FIGS. 1-3, in accordance with one or more embodiments of the present invention, HDD 101 may further include: a plurality of magnetic-recording disks, of which magnetic-recording disk 120 is an example; an integrated L/UL ramp structure 190 including a L/UL ramp-structure portion 190a including a plurality 190a-2 of L/UL ramps 190a-21, 190a-22, 190a-23, 190a-24, 190a-25, and 190a-26, by way of example without limitation thereto, and a bracket portion 190a-1 integrally attached to the plurality 190a-2 of L/UL ramps 190a-21 through 190a-26; a plurality 190c of downstream spoilers 190c-1 and 190c-2, by way of example without limitation thereto, integrally attached to the L/UL ramp-structure portion 190a; and the slit-shroud 190b including a plurality of wings 190b-1, 190b-2 and 190b-3, by way of example without limitation thereto, such that the plurality of wings 190b-1, 190b-2 and 190b-3 is integrally attached to the L/UL ramp-structure portion 190a. In accordance with one or more embodiments of the present invention, the integrated L/UL ramp structure 190 is shown in FIG. 2 as configured for a HDD with a plurality of three magnetic-recording disks and a plurality of six magnetic-recording heads, such that the integrated L/UL ramp structure 190 shown in FIG. 2 is configured with the plurality 190c of two downstream spoilers 190c-1 and 190c-2, the plurality of three wings 190b-1, 190b-2 and 190b-3, and the plurality 190a-2 of six L/UL ramps 190a-21, 190a-22, 190a-23, 190a-24, 190a-25, and 190a-26; but, the configuration of the integrated L/UL ramp structure 190 shown in FIG. 2 is by way of example without limitation thereto, as HDDs and integrated L/UL ramp structures with fewer or more component parts than suggested or shown in FIG. 2 are also within the spirit and scope of embodiments of the present invention. Notwithstanding the number of component parts included in an integrated L/UL ramp structure, such as the integrated L/UL ramp structure 190, in accordance with one or more embodiments of the present invention, at least one L/UL ramp, for example, L/UL ramp 190a-21, of the plurality of L/UL ramps is configured to lift a head-slider, for example, head-slider 110b, away from a recording surface of the magnetic-recording disk, for example, magnetic-recording disk 120; the bracket portion 190a-1 is configured to allow affixing the integrated L/UL ramp structure 190 in a static position in a disk-enclosure base 168 of HDD 101; each downstream spoiler, for example, one of downstream spoilers 190c-1 and 190c-2, of a plurality of downstream spoilers is configured for operation in a respective airflow downstream from one or more respective head-sliders; and, each wing, for example, one of wings 190b-1, 190b-2 and 190b-3, of a plurality of wings is configured to suppress respective axial airflow components in close proximity to a respective OD edge of a respective magnetic-recording disk, for example, magnetic-recording disk 120 corresponding to wing 190b-1.

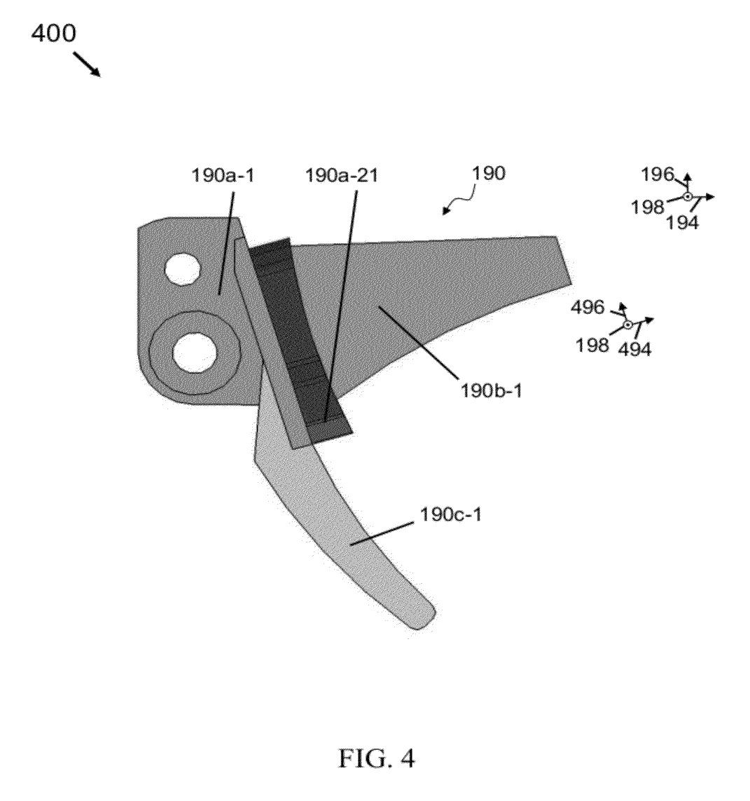

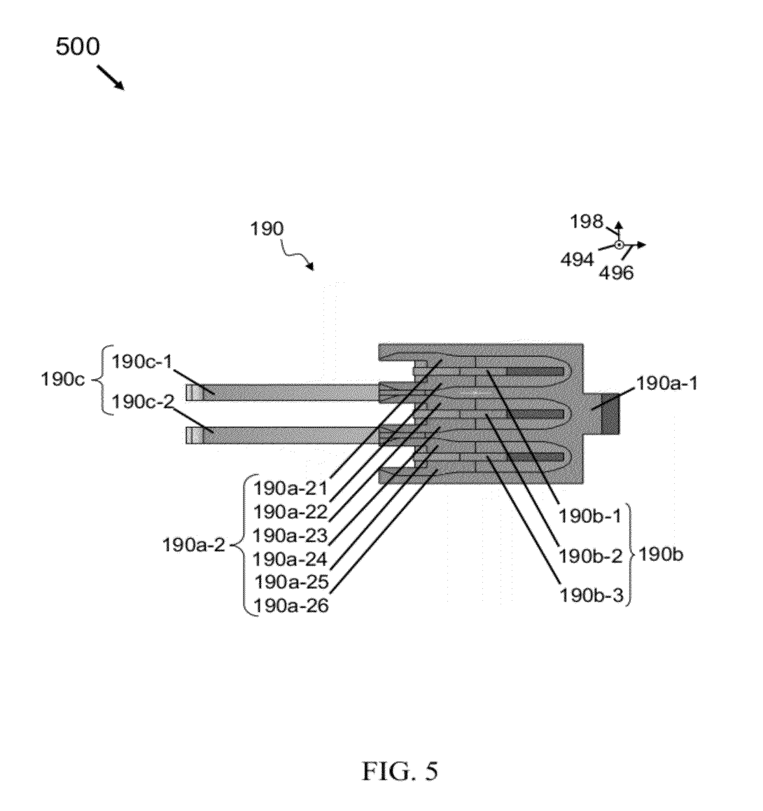

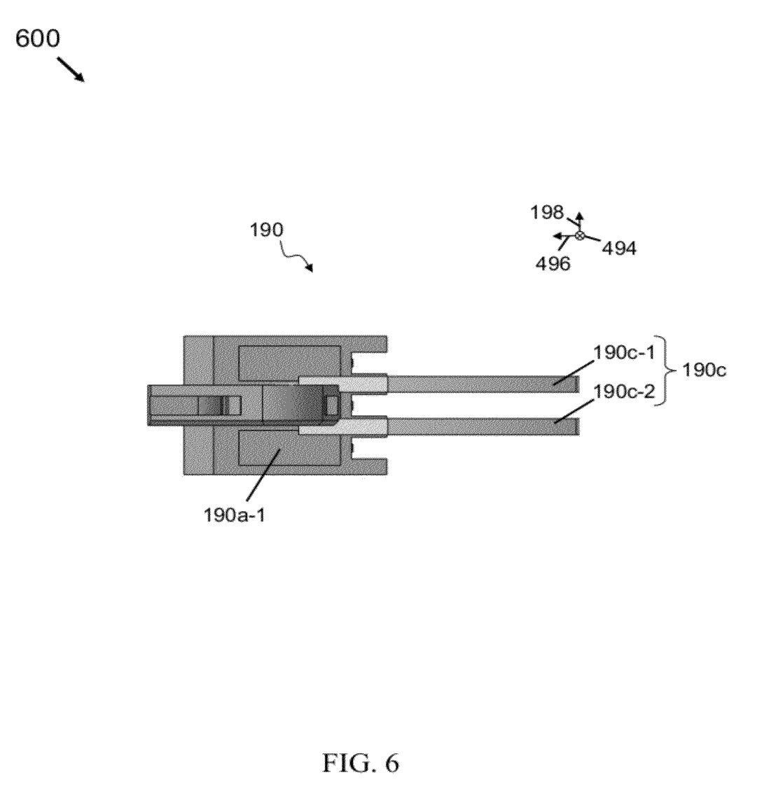

With reference now to FIG. 4 and further reference to FIGS. 1-3, in accordance with one or more embodiments of the present invention, a plan view 400 is shown of the integrated L/UL ramp structure 190 including a L/UL ramp-structure portion 190a, at least one downstream spoiler 190c-1, and a slit-shroud 190b including at least one wing 190b-1. As shown in FIG. 4, the triad of arrows 194, 196 and 198 indicates the orientation in which the integrated L/UL ramp structure 190 is viewed in the plan view 400. Also shown in FIG. 4 is a second triad of arrows 494, 496 and 198 that indicates the orientation of the bracket portion 190a-1 relative to the airflow direction above the magnetic-recording disk 120 in HDD 101. As shown in FIG. 4, the direction of arrow 496 is about parallel to the LE side of the bracket portion 190a-1 of the L/UL ramp-structure portion 190a; the direction of arrow 494 is perpendicular to arrow 496 and is perpendicular to the LE side of the bracket portion 190a-1 of the L/UL ramp-structure portion 190a; and, the arrow 198, which is indicated by the arrow head of arrow 198, is about perpendicular to the plane of the disk-enclosure base 168, as well as the plane of the recording surface of the magnetic recording disk 120, as previously described, and is also perpendicular to arrows 494 and 496. The second triad of arrows 494, 496 and 198 is useful for indicating the orientation of component parts of the integrated L/UL ramp structure 190 shown in FIG. 4, as well as views for the subsequently described drawings of the integrated L/UL ramp structure 190 that are shown in FIGS. 5 and 6.

With further reference to FIGS. 1-4, in accordance with one or more embodiments of the present invention, a downstream spoiler, for example, downstream spoiler 190c-1, may be configured to produce a quiet zone, for example, quiet zone 191, in airflow above the magnetic-recording disk 120; and, the quiet zone, for example, quiet zone 191, is located ahead of a leading edge of the downstream spoiler, for example, downstream spoiler 190c-1, which is the side of the downstream spoiler that is facing about in the direction of arrow 494. In accordance with one or more embodiments of the present invention, the downstream spoiler, for example, downstream spoiler 190c-1, is composed of a material stiff enough to provide sufficient rigidity of the downstream spoiler in an airflow of HDD 101 to prevent interference between the downstream spoiler and the magnetic-recording disk, for example, magnetic-recording disk 120, due to FIV of the downstream spoiler produced by the airflow.

With further reference to FIGS. 1-4, in accordance with one or more embodiments of the present invention, the integrated L/UL ramp structure 190 may further include a single integral molded component. Thus, in accordance with embodiments of the present invention, the integrated L/UL ramp structure 190 may be fabricated at lower cost than a structure in which the individual component parts of the integrated L/UL ramp structure 190 are fabricated of different materials, because separate molding operations for the individual parts are avoided, as well as the operation of assembling the individual component parts into the integrated L/UL ramp structure 190. Moreover, in accordance with one or more embodiments of the present invention, the integrated L/UL ramp structure 190 includes a slit-shroud 190b including one or more wings, of which wings 190b-1, 190b-2 and 190b-3 are examples, without an attached vertical curtain portion skirting the sides of the wings that face away from the OD edge of the magnetic-recording disk, or disks, of which magnetic-recording disk 120 is an example. Thus, in accordance with embodiments of the present invention, the integrated L/UL ramp structure 190 including the slit-shroud 190b including one or more wings without the attached vertical curtain portion skirting the sides of the wings that face away from the OD edge of the magnetic-recording disk, or disks, also eliminates a component part that is difficult to fabricate and assemble.

With further reference to FIGS. 1-4, in accordance with one or more embodiments of the present invention, the L/UL ramp-structure portion 190a includes at least one L/UL ramp, of which L/UL ramp 190a-21 is an example, configured to lift a head-slider, for example, head-slider 110b, away from a recording surface of the magnetic-recording disk, for example, magnetic-recording disk 120, and a bracket portion 190a-1 integrally attached to the L/UL ramp and configured to allow affixing the integrated L/UL ramp structure 190 in a static position in the disk-enclosure base 168 of HDD 101. In accordance with one or more embodiments of the present invention, at least one L/UL ramp, of which L/UL ramp 190a-21 is an example, of the L/UL ramp-structure portion 190a includes a material with a low coefficient of friction to facilitate sliding of a tongue 110e of HGA 110 both off of, and onto, the L/UL ramp, when both loading the head-slider, for example, head-slider 110b, onto the magnetic-recording disk, for example, magnetic-recording disk 120, and unloading the head-slider from the magnetic-recording disk, respectively. In accordance with one or more embodiments of the present invention, at least one L/UL ramp, of which L/UL ramp 190a-21 is an example, of the L/UL ramp-structure portion 190a may include a material selected from the group consisting of nylon, a polyamide polymer compound, polytetrafluoroethylene (PTFE), a fluorinated plastic, and a plastic material with a low coefficient of friction.

With reference now to FIG. 5 and further reference to FIGS. 1-4, in accordance with one or more embodiments of the present invention, a side view 500 of one side of the bracket portion 190a-1 of the integrated L/UL ramp structure 190 is shown as viewed from a substantially upstream viewpoint illustrating the arrangement of components parts of the integrated L/UL ramp structure 190 of FIG. 2. As shown in FIG. 5, the triad of arrows 494, 496 and 198 indicates the orientation in which the integrated L/UL ramp structure 190 is viewed in the side view 500, which is parallel to, but opposite to the sense of, the arrow 494 is such that the integrated L/UL ramp structure 190 is presented as the integrated L/UL ramp structure 190 appears when looking essentially downstream towards a upstream-facing side of the integrated L/UL ramp structure 190. In accordance with one or more embodiments of the present invention, a plurality of cutouts in the L/UL ramp-structure portion 190a are provided to allow a plurality of respective tapered portions of the plurality 190a-2 of L/UL ramps 190a-21, 190a-22, 190a-23, 190a-24, 190a-25, and 190a-26 to extend out over the respective top and bottom recording surfaces of a plurality of magnetic-recording disks, of which magnetic-recording disk 120 is an example. In accordance with one or more embodiments of the present invention, the plurality of respective tapered portions of the plurality 190a-2 of L/UL ramps 190a-21 through 190a-26 is configured to allow lifting of each respective tongue of each HGA, of which tongue 110e of HGA 110 is an example, corresponding to a respective recording surface of respective magnetic recording disks, of which the top recording surface of magnetic-recording disk 120 is an example, in loading and unloading operations of a respective head-slider, for example, head-slider 110b.

With further reference to FIGS. 1-5, in accordance with one or more embodiments of the present invention, the L/UL ramps are of two types: top-side L/UL ramps that lift the tongue of a head-slider from a top recording surface of a magnetic recording disk, for example, L/UL ramps 190a-21, 190a-23 and 190a-25; and, bottom-side L/UL ramps that lift the tongue of a head-slider from a bottom recording surface of a magnetic recording disk, for example, L/UL ramps 190a-22, 190a-24 and 190a-26. In FIG. 5, the integrated L/UL ramp structure 190 is also shown with the plurality 190c of downstream spoilers 190c-1 and 190c-2 facing upstream as viewed when facing the LE sides of the plurality 190c of downstream spoilers 190c-1 and 190c-2. In accordance with one or more embodiments of the present invention, in between a plurality of magnetic-recording disks, the plurality 190c of downstream spoilers 190c-1 and 190c-2 creates a plurality of quiet zones, of which quiet zone 191 on the bottom side of magnetic recording disk 120 is an example, in front of the LE sides of the plurality 190c of downstream spoilers 190c-1 and 190c-2; in this regard, it is noted that the downstream spoiler 190c-1 shown in FIG.1 lies underneath and facing the bottom side of magnetic-recording disk 120, as indicated by the dotted line outline of downstream spoiler 190c-1 in FIG. 1. Thus, by way of example without limitation thereto, in accordance with one or more embodiments of the present invention, the plurality 190c of downstream spoilers 190c-1 and 190c-2 is configured to be disposed in an interdigitated manner between a plurality of magnetic-recording disks (not shown) of HDD 101, of which magnetic-recording disk 120 is an example; alternatively, downstream spoilers that are provided for every recording surface of a plurality magnetic-recording disks are also with the spirit and scope of embodiments of the present invention, even though the plurality 190c of downstream spoilers 190c-1 and 190c-2 shown in FIGS. 1-3 and 5 provide quiet zones for only some of the recording surfaces of a disk stack including just three magnetic-recording disks. As shown in FIG. 5, the plurality of wings 190b-1, 190b-2 and 190b-3 are attached to a front side, or LE side, of the L/UL ramp-structure portion 190a being disposed between the plurality 190a-2 of top-side L/UL ramps 190a-21, 190a-23 and 190a-25 and bottom-side L/UL ramps 190a-22, 190a-24 and 190a-26, with each of the wings 190b-1, 190b-2 and 190b-3 sandwiched between a respective top-side/bottom-side L/UL ramp pair 190a-21 and 190a-22, 190a-23 and 190a-24, and 190a-25 and 190a-26.

With reference now to FIG. 6 and further reference to FIGS. 1-5, in accordance with one or more embodiments of the present invention, a side view 600 of the side of the bracket portion 190a-1 of the integrated L/UL ramp structure 190 opposite to that shown in FIG. 5 is shown as viewed from a substantially downstream viewpoint illustrating the arrangement of components parts of the integrated L/UL ramp structure 190 of FIG. 2. As shown in FIG. 6, the triad of arrows 494, 496 and 198 indicates the orientation in which the integrated L/UL ramp structure 190 is viewed in the side view 600, which is parallel to, and in the sense of, the arrow 494 is such that the integrated L/UL ramp structure 190 is presented as the integrated L/UL ramp structure 190 appears when looking essentially upstream towards a downstream-facing side of the integrated L/UL ramp structure 190. As shown in FIG. 6, the plurality 190c of downstream spoilers 190c-1 and 190c-2 are attached to a downstream-facing side, or TE side, of the L/UL ramp-structure portion 190a.

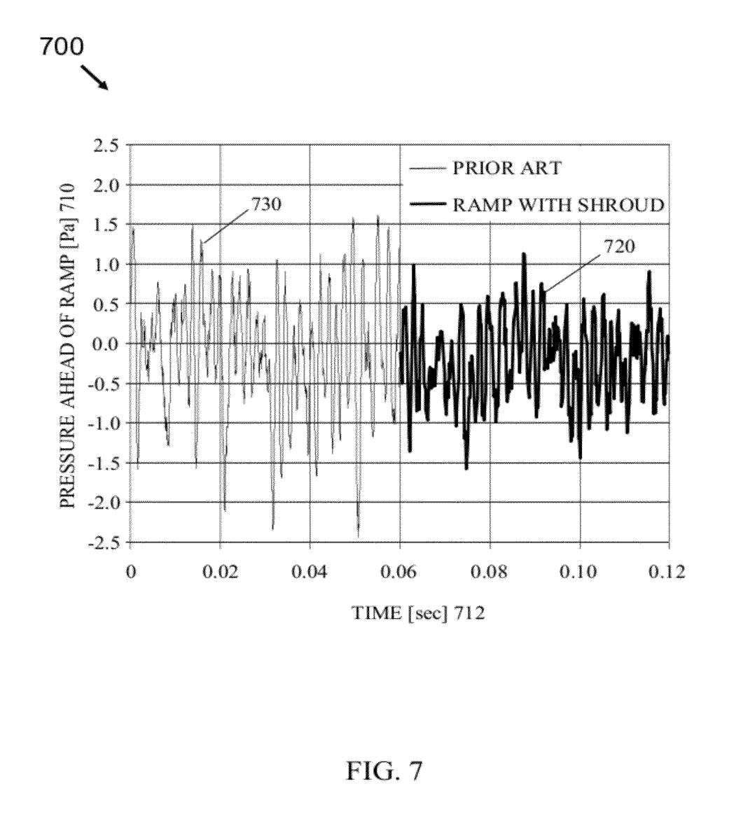

With further reference to FIGS. 1-6, with relevance for embodiments of the present invention, the most sensitive components of an HDD are the lead-suspension 110c and the head-slider 110b, which, in the absence of embodiments of the present invention, operate close to a highly disturbed airflow region in proximity to L/UL ramps. In accordance with one or more embodiments of the present invention, L/UL ramps with integrated downstream spoilers, similar to downstream spoilers 190c-1 and 190c-2, are used to create an upstream wake to place the lead-suspension 110c in a quiet zone 191, when operating HDD 101. In the absence of embodiments of the present invention, a L/UL ramp, from an aerodynamic point of view, is one of the most unwelcome components in an HDD, because the L/UL ramp is located in a region of maximum airflow velocity that is present at the recording surface and OD edge of a magnetic-recording disk. Consequently, in the absence of embodiments of the present invention, the L/UL ramp is responsible for a not insignificant power loss in HDD operation. In the absence of embodiments of the present invention, values of power loss approaching 1 watt (W) in HDDs operating at 15×10³ revolutions/minute (rpm) with 70 mm magnetic-recording disks are possible; and, also, in small-form-factor (SFF) HDDs at 10 krpm, similar power loss can be as large as 0.3 W. Bluff bodies often benefit from upstream appendages such as, plates, and other smaller bluff bodies. In accordance with one or more embodiments of the present invention, the wings 190b-1, 190b-2 and 190b-3 of the slit-shroud 190b perform the role of forebodies that may interfere favorably with the plurality 190a-2 of L/UL ramps 190a-21, 190a-22, 190a-23, 190a-24, 190a-25, and 190a-26. To the inventors' knowledge, the technique of using the wings of a slit-shroud 190b to perform the role of forebodies has not been used in connection with L/UL ramp streamlining, although the function of L/UL ramp streamlining is sub-ordinate to the function of the forebody wings used as suppressors of axial turbulent flow components in the airflow, as previously described. In experiments performed by the inventors, the drive-motor currents were measured and found to be reduced on the order of a few milliamperes (mA) at 10 krpm with 65 mm magnetic-recording disks, when forebody streamlining was used for L/UL ramps, in accordance with embodiments of the present invention. Thus, in accordance with embodiments of the present invention, power consumption can be reduced in HDD 101 including the integrated L/UL ramp structure 190 including the slit-shroud 190b with the plurality of wings 190b-1, 190b-2 and 190b-3. Moreover, in accordance with embodiments of the present invention, the integrated L/UL ramp structure 190 including the slit-shroud 190b is configured to reduce airflow turbulence in the vicinity of a L/UL ramp, of which L/UL ramp 190a-21 is an example, as next described with reference to the data presented in FIG. 7.

With reference now to FIG. 7, in accordance with one or more embodiments of the present invention, plots 700 of pressure 710 ahead of a L/UL ramp versus time 712 are shown. In FIG. 7, an adjacent plot 720, in accordance with embodiments of the present invention, of pressure 710 ahead of a L/UL ramp with a slit-shroud as a function of time 712 at a location where a wing of the slit-shroud is located is compared to a plot 730 (prior art) of pressure ahead of a L/UL ramp without a slit-shroud as a function of time at the same location but without the wing of the slit-shroud being present. As shown in FIG. 7, the pressure was measured at the location just outside an OD edge of the magnetic-recording disk, similar to the OD edge 124 magnetic-recording disk 120, upstream from a L/UL ramp, of which L/UL ramp 190a-21 is an example; the plot 720 of the pressure 710 versus time 712 trace was measured at a location over a wing, similar to wing 190b-1; and, the plot 730 of the pressure 710 versus time 712 trace was measured at the same location without the wing. The variance in pressure without the wing was about 2.5 times higher than the variance in pressure with the wing, similar to wing 190b-1 in accordance with embodiments of the present invention. Thus, in accordance with one or more embodiments of the present invention, the integrated L/UL ramp structure is configured to reduce a variance in, or a root-mean-square (rms) value of, pressure as a function of time at a location just outside an OD edge of a magnetic-recording disk upstream from a L/UL ramp, of which L/UL ramp 190a-21 is an example, where a wing, for example, wing 190b-1, of the slit-shroud 190b is disposed, relative to a variance in pressure as a function of time at the location just outside the OD edge of the magnetic-recording disk upstream from a L/UL ramp in the absence of a wing of the slit-shroud 190b from the location. Moreover, in accordance with one or more embodiments of the present invention, the integrated L/UL ramp structure is configured to reduce a variance in, or a root-mean-square (rms) value of, pressure by greater than about a factor of 2.5, as the pressure varies as a function of time at a location just outside an OD edge of a magnetic-recording disk upstream from a L/UL ramp, of which L/UL ramp 190a-21 is an example, where a wing, for example, wing 190b-1, of the slit-shroud 190b is disposed, relative to a variance in pressure as a function of time at the location just outside the OD edge of the magnetic-recording disk upstream from a L/UL ramp in the absence of a wing of the slit-shroud 190b from the location.

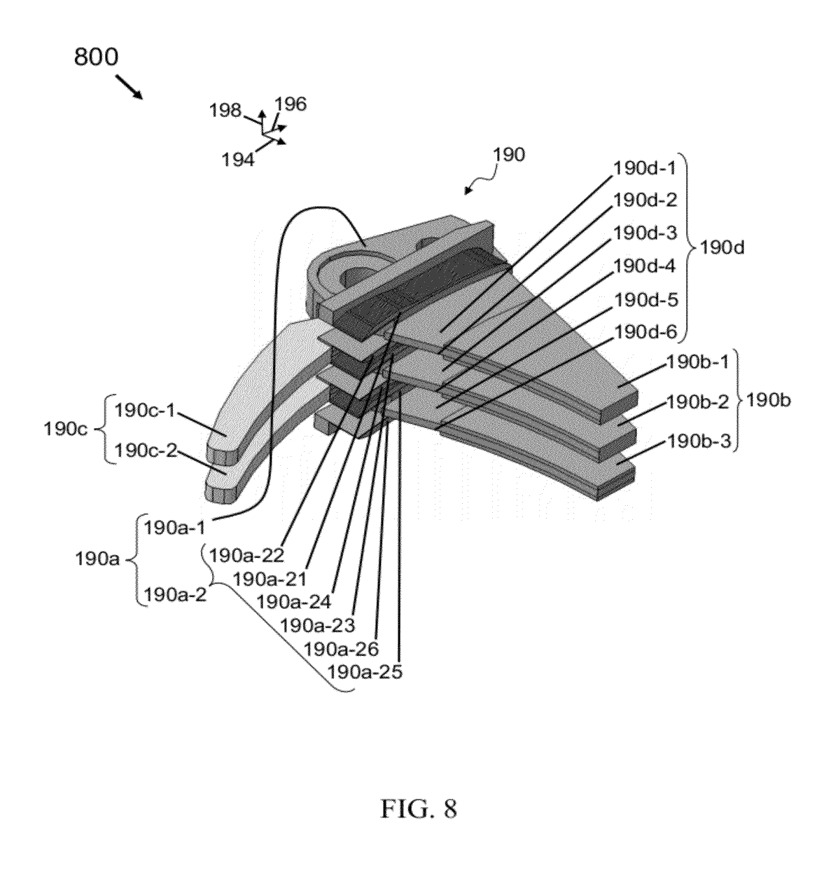

With reference now to FIG. 8 and further reference to FIGS. 1 and 2, in accordance with one or more embodiments of the present invention, a perspective view 800 is shown of the integrated L/UL ramp structure 190 including a slit-shroud 190b including a plurality 190d of head-slider channels 190d-1, 190d-2, 190d-3, 190d-4, 190d-5, and 190d-6. In accordance with one or more embodiments of the present invention, a head-slider channel accommodates unloading of a head-slider without interference with the slit-shroud, for example, with a wing of the slit-shroud in proximity to the head-slider as the head-slider is unloaded from the recording surface of a magnetic-recording disk. As shown in FIG. 8, the triad of arrows 194, 196 and 198 indicates the orientation in which the integrated L/UL ramp structure 190 is viewed in perspective view 800, which is similar to the orientation in which the integrated L/UL ramp structure 190 is viewed in perspective view 200 of FIG. 2; thus, perspective view 800 facilitates comparison of the differences between embodiments of the present invention for the integrated L/UL ramp structure 190 shown in FIG. 8 and embodiments of the present invention for the integrated L/UL ramp structure 190 shown in FIG. 2. As shown in FIG. 8, in accordance with one or more embodiments of the present invention, the integrated L/UL ramp structure 190 includes: the L/UL ramp-structure portion 190a including a plurality 190a-2 of L/UL ramps 190a-21, 190a-22, 190a-23, 190a-24, 190a-25, and 190a-26, by way of example without limitation thereto, and the bracket portion 190a-1 integrally attached to the plurality 190a-2 of L/UL ramps 190a-21 through 190a-26; a plurality 190c of downstream spoilers 190c-1 and 190c-2, by way of example without limitation thereto, integrally attached to the L/UL ramp-structure portion 190a; and the slit-shroud 190b including a plurality of wings 190b-1, 190b-2 and 190b-3, by way of example without limitation thereto, such that the plurality of wings 190b-1, 190b-2 and 190b-3 is integrally attached to the L/UL ramp-structure portion 190a. In accordance with one or more embodiments of the present invention, the integrated L/UL ramp structure 190 is shown in FIG. 2 as configured for a HDD with a plurality of three magnetic-recording disks and a plurality of six magnetic-recording heads, such that the integrated L/UL ramp structure 190 shown in FIG. 8 is configured with the plurality 190c of two downstream spoilers 190c-1 and 190c-2, the plurality of three wings 190b-1, 190b-2 and 190b-3, and the plurality 190a-2 of six L/UL ramps 190a-21, 190a-22, 190a-23, 190a-24, 190a-25, and 190a-26. In accordance with one or more embodiments of the present invention, by way of example without limitation thereto, the slit-shroud 190b including the plurality of wings 190b-1, 190b-2 and 190b-3 further includes a plurality 190d of head-slider channels 190d-1, 190d-2, 190d-3, 190d-4, 190d-5, and 190d-6; each of the wings 190b-1, 190b-2 and 190b-3 includes a pair of head-slider channels 190d-1 and 190d-2, 190d-3 and 190d-4, and 190d-5 and 190d-6, respectively. In accordance with one or more embodiments of the present invention, by way of example without limitation thereto, the plurality 190d of head-slider channels 190d-1 through 190d-6 is configured to allow both loading and unloading of a plurality of head-sliders, of which head-slider 110b is an example, from a plurality of magnetic-recording disks, of which magnetic-recording disk 120 is an example, without interference between the head-sliders and the slit-shroud 190b, particularly the wings 190b-1, 190b-2 and 190b-3 of slit-shroud 190b. In accordance with one or more embodiments of the present invention, by way of example without limitation thereto, the plurality 190d of head-slider channels 190d-1, 190d-2, 190d-3, 190d-4, 190d-5, and 190d-6 is disposed in proximity to the plurality 190a-2 of respective L/UL ramps 190a-21, 190a-22, 190a-23, 190a-24, 190a-25, and 190a-26; head-slider channels 190d-1, 190d-3, and 190d-5 are top head-slider channels disposed to accommodate top head-sliders, of which head-slider 110b is an example; and, head-slider channels 190d-2, 190d-4, and 190d-6 are bottom head-slider channels disposed to accommodate bottom head-sliders (not shown). Thus, in accordance with one or more embodiments of the present invention, the slit-shroud 190b further includes at least one head-slider channel, of which head-slider channel 190d-1 is an example; and, the head-slider channel is configured to allow both loading and unloading of a head-slider from a magnetic-recording disk, for example, head-slider 110b from magnetic-recording disk 120, without interference between the head-slider and the slit-shroud 190b.

### Description of Embodiments of the Present Invention for a Method for Assembling a Hard-Disk Drive with an Integrated Load-Unload Ramp Structure

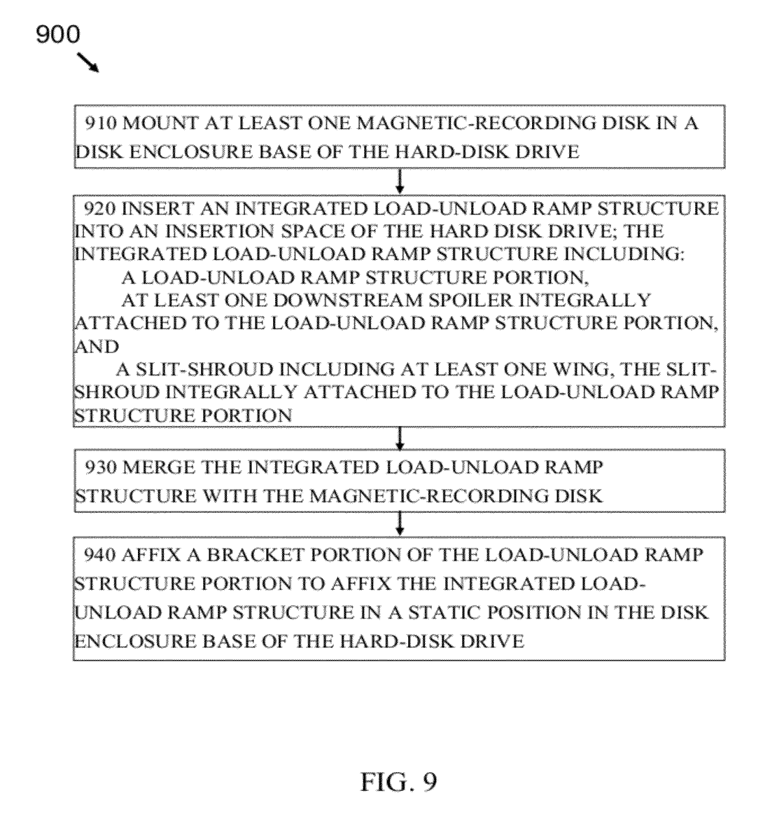

With reference to FIG. 9, in accordance with one or more embodiments of the present invention, a flow chart 900 is shown of a method for assembling a HDD with an integrated load-unload ramp structure. The method includes the following. At 910, at least one magnetic-recording disk is mounted in a disk enclosure base of the HDD. At 920, an integrated load-unload ramp structure is inserted into an insertion space of the hard disk drive. As described above in greater detail, in accordance with one or more embodiments of the present invention, the integrated load-unload ramp structure includes a load-unload ramp-structure portion, at least one downstream spoiler that is integrally attached to the load-unload ramp-structure portion, and a slit-shroud including at least one wing, such that the slit-shroud is integrally attached to the load-unload ramp-structure portion. At 930, the integrated load-unload ramp structure is merged with the magnetic-recording disk. In accordance with one or more embodiments of the present invention, merging may further include sliding the integrated load-unload ramp structure in a linear translation across the insertion space. Alternatively, in accordance with one or more embodiments of the present invention, merging may further include rotating the downstream spoiler about a pivot, and locking the downstream spoiler into position with respect to a recording surface of the magnetic-recording disk. At 940, a bracket portion of the load-unload ramp-structure portion is affixed to the disk enclosure base of the HDD such that the integrated load-unload ramp structure is fixed in a static position in the disk enclosure base of the HDD. In accordance with one or more embodiments of the present invention, the method may further include employing a robot to perform an operation in assembling the HDD.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. An integrated load-unload ramp structure with a downstream spoiler and a slit-shroud for a hard-disk drive, said integrated load-unload ramp structure comprising:
a load-unload ramp-structure portion, said load-unload ramp-structure portion configured both for loading, and for unloading, at least one head-slider from at least one magnetic-recording disk;
at least one downstream spoiler, said downstream spoiler integrally attached to said load-unload ramp-structure portion and configured for operation in an airflow downstream from said head-slider; and
said slit-shroud comprising at least one wing, said slit-shroud integrally attached to said load-unload ramp-structure portion and configured to suppress axial airflow components in close proximity to an outside-diameter edge of said magnetic-recording disk.

2. The integrated load-unload ramp structure of claim 1, wherein said downstream spoiler is configured to produce a quiet zone in airflow above said magnetic-recording disk, said quiet zone located ahead of a leading edge of said downstream spoiler.

3. The integrated load-unload ramp structure of claim 2, wherein said downstream spoiler is configured to pivot and be locked into position adjacent to a location where said quiet zone is to be created in airflow above said magnetic-recording disk.

4. The integrated load-unload ramp structure of claim 1, wherein said downstream spoiler is composed of a material stiff enough to provide sufficient rigidity of said downstream spoiler in an airflow of said hard-disk drive to prevent interference between said downstream spoiler and said magnetic-recording disk due to flow-induced vibration of said downstream spoiler produced by said airflow.

5. The integrated load-unload ramp structure of claim 1, wherein said slit-shroud further comprises:
at least one head-slider channel;
wherein said head-slider channel is configured to allow both loading and unloading of said head-slider from said magnetic-recording disk without interference between said head-slider and said slit-shroud.

6. The integrated load-unload ramp structure of claim 1, further comprising:
a single integral molded component.

7. The integrated load-unload ramp structure of claim 1, wherein said load-unload ramp-structure portion comprises:
at least one load-unload ramp configured to lift said head-slider away from a recording surface of said magnetic-recording disk; and
a bracket portion integrally attached to said load-unload ramp, and configured to allow affixing said integrated load-unload ramp structure in a static position in a disk enclosure base of said hard-disk drive.

8. The integrated load-unload ramp structure of claim 7, wherein at least said load-unload ramp of said load-unload ramp-structure portion comprises a material with a low coefficient of friction to facilitate sliding of a tongue of a head-gimbal assembly both off of, and onto, said load-unload ramp, when both loading said head-slider onto said magnetic-recording disk, and unloading said head-slider from said magnetic-recording disk, respectively.

9. The integrated load-unload ramp structure of claim 7, wherein at least said load-unload ramp of said load-unload ramp-structure portion comprises a material selected from the group consisting of nylon, a polyamide polymer compound, polytetrafluoroethylene, a fluorinated plastic, and a plastic material with a low coefficient of friction.

10. A hard-disk drive, comprising:
at least one magnetic-recording disk;
at least one head-slider, said head-slider configured to access data on said magnetic recording disk;
at least one magnetic-recording head disposed at a distal end of said head-slider, said magnetic-recording head configured to read data from, and to write data to, said magnetic-recording disk; and
an integrated load-unload ramp structure with a downstream spoiler and a slit-shroud, said integrated load-unload ramp structure comprising:
a load-unload ramp-structure portion, said load-unload ramp-structure portion configured both for loading, and for unloading, said head-slider from said magnetic-recording disk;
at least one downstream spoiler, said downstream spoiler integrally attached to said load-unload ramp-structure portion and configured for operation in an airflow downstream from said head-slider; and
said slit-shroud comprising at least one wing, said slit-shroud integrally attached to said load-unload ramp-structure portion and configured to suppress axial airflow components in close proximity to an outside-diameter edge of said magnetic-recording disk.

11. The hard-disk drive of claim 10, wherein a longitudinal axis of said downstream spoiler is disposed in a substantially radial orientation with respect to said magnetic-recording disk; and
wherein a length of said longitudinal axis of said downstream spoiler is about one half a distance from an outside diameter to an inside diameter of said magnetic-recording disk.

12. The hard-disk drive of claim 10, wherein said downstream spoiler is configured to produce a quiet zone in airflow above said magnetic-recording disk, said quiet zone located ahead of a leading edge of said downstream spoiler.

13. The hard-disk drive of claim 10, wherein said integrated load-unload ramp structure is configured to reduce a variance in pressure as a function of time at a location just outside an outside-diameter edge of said magnetic-recording disk upstream from a load-unload ramp where a wing of said slit-shroud is disposed, relative to a variance in pressure as a function of time at said location just outside said outside-diameter edge of said magnetic-recording disk upstream from said load-unload ramp in absence of a wing of said slit-shroud from said location.

14. The hard-disk drive of claim 10, wherein said integrated load-unload ramp structure is configured to reduce a variance in pressure as a function of time by greater than about a factor of 2.5 at a location just outside an outside-diameter edge of said magnetic-recording disk upstream from a load-unload ramp where a wing of said slit-shroud is disposed, relative to a variance in pressure as a function of time at said location just outside said outside-diameter edge of said magnetic-recording disk upstream from said load-unload ramp in absence of a wing of said slit-shroud from said location.

15. The hard-disk drive of claim 10, wherein said integrated load-unload ramp structure is configured to reduce track misregistration of said head-slider when said head-slider accesses data on said magnetic-recording disk.

16. The hard-disk drive of claim 10, further comprising:
an insertion space for said integrated load-unload ramp structure, said insertion space configured to receive said integrated load-unload ramp structure in an assembly operation, and configured to allow a sliding-insertion operation of at least one downstream spoiler of said integrated load-unload ramp structure into proximity with a recording surface of said magnetic recording disk.

17. The hard-disk drive of claim 10, wherein a disk-edge-facing side of said wing of said slit-shroud is disposed in close proximity to said magnetic-recording disk and conforms to a curved contour of an outside-diameter edge of said magnetic-recording disk.

18. The hard-disk drive of claim 17, wherein a thickness of said wing of said slit-shroud is on an order of a thickness of said magnetic-recording disk.

19. The hard-disk drive of claim 10, further comprising:
a plurality of magnetic-recording disks;
said load-unload ramp-structure portion comprising:
a plurality of load-unload ramps, at least one load-unload ramp of said plurality of load-unload ramps configured to lift a head-slider away from a recording surface of said magnetic-recording disk; and
a bracket portion integrally attached to said plurality of load-unload ramps, and configured to allow affixing said integrated load-unload ramp structure in a static position in a disk enclosure base of said hard-disk drive; and
a plurality of downstream spoilers, said plurality of downstream spoilers integrally attached to said load-unload ramp-structure portion, and at least one downstream spoiler of said plurality of downstream spoilers configured for operation in a respective airflow downstream from at least one head-slider; and
said slit-shroud comprising a plurality of wings, said plurality of wings integrally attached to said load-unload ramp-structure portion, and at least one wing of said plurality of wings configured to suppress respective axial airflow components in close proximity to a respective outside-diameter edge of a respective magnetic-recording disk.

20. The hard-disk drive of claim 19, wherein said plurality of downstream spoilers is disposed in an interdigitated manner between said plurality of magnetic-recording disks.

21. A method for assembling a hard-disk drive with an integrated load-unload ramp structure, said method comprising:
mounting at least one magnetic-recording disk in a disk enclosure base of said hard-disk drive;
inserting an integrated load-unload ramp structure into an insertion space of said hard disk drive, said integrated load-unload ramp structure comprising:
a load-unload ramp-structure portion, at least one downstream spoiler integrally attached to said load-unload ramp-structure portion, and a slit-shroud comprising at least one wing, said slit-shroud integrally attached to said load-unload ramp-structure portion;
merging said integrated load-unload ramp structure with said magnetic-recording disk;
affixing a bracket portion of said load-unload ramp-structure portion to affix said integrated load-unload ramp structure in a static position in said disk enclosure base of said hard-disk drive.

22. The method of claim 21, further comprising:
employing a robot to perform an operation in said assembling said hard-disk drive.

23. The method of claim 21, wherein said merging further comprises:
sliding said integrated load-unload ramp structure in a linear translation across said insertion space.

24. The method of claim 21, wherein said merging further comprises:
rotating said downstream spoiler about a pivot; and
locking said downstream spoiler into position with respect to a recording surface of said magnetic-recording disk.
